(19) United States
(12) Patent Application Publication
(10) Pub. No.: US 2022/0007616 A1
(43) Pub. Date: Jan. 13, 2022

(54) INTEGRATED MULTI-COLOR ANIMAL CHEW TOY AND PREPARATION PROCESS THEREOF

(71) Applicant: Dongguan Jiandong Rubber Products Technology Co. , Ltd., Guangdong Province (CN)

(72) Inventor: Xiaodong Geng, Dongguan City (CN)

(21) Appl. No.: 17/033,939

(22) Filed: Sep. 28, 2020

(30) Foreign Application Priority Data
Jul. 13, 2020 (CN) 202010671409.1

(51) Int. Cl. A01K 15/02; B29C 45/16

(52) U.S. Cl. CPC A01K 15/026; B29L 2031/5209; B29K 2995/0021; B29C 45/1615

(57) ABSTRACT

An integrated multi-color animal chew toy and preparation process thereof, including selecting N types of rubbers used to form a product, wherein the rubbers have different colors and different hardness; selecting one type of rubber from the rubbers used to form the product, putting the rubber selected into a first mold, and performing mold forming to form a first molded product; putting part of the first molded product into a second mold, closing the second mold, and then injecting a second rubber selected from the rubbers used to form the product for mold forming to form a second molded product; putting part of the second molded product into a Nth mold, closing the Nth mold, and then injecting a Nth rubber selected from the rubbers used to form the product for mold forming, and then cooling to obtain the product completely.

### CROSS REFERENCE TO RELATED DISCLOSURE

This disclosure claims priority benefit of Chinese Patent disclosure No. CN202010671409.1, filed on Jul. 13, 2020, and the entire contents of which are incorporated herein by reference.

### TECHNICAL FIELD

The present disclosure relates to the technical field of animal toy, more specifically, relating to an integrated multi-color animal chew toy and the preparation process thereof.

### BACKGROUND

Most dogs like to bite things, but they prefer different hardness. Most adult dogs like hard things, while some dogs cannot chew on hard things because of their age, and little dogs have underdeveloped teeth and cannot chew on hard things, so that these dogs can only chew soft things. The existing animal chew toy can only be made to one product with one hardness, which can not satisfy the requirement of soft and hard coexistence on one product, and the color of the existing animal chew toy is single, which is not beautiful. There are also a small number of animal chew toy made with two kinds of hardness and two colors, they are not formed by chemical integration in one body, but connected with buckle or glue. The buckle connection increases the cost of assembly process, such that the product is easy to be damaged because the strong biting force and tearing force caused by animal chewing.

### SUMMARY

In view of the deficiencies of the prior art, the first objective of the present disclosure is to provide a preparation process of an integrated multi-color animal chew toy, which has the advantages of forming rubber of different colors in one body, so that the structural strength of the product is higher.

The first objective of the disclosure is realized by the following technical solution: a preparation process of an integrated multi-color animal chew toy, which includes the following steps:

Material selection: selecting N types of rubbers used to form a product, wherein the rubbers have different colors and different hardness;

The first time of processing: selecting one type of rubber from the rubbers used to form the product, putting the rubber selected into a first mold, and performing mold forming to form a first molded product;

The second time of processing: putting part of the first molded product into a second mold, closing the second mold, and then injecting a second rubber selected from the rubbers used to form the product for mold forming to form a second molded product;

N times of processing: putting part of the second molded product into a Nth mold, closing the Nth mold, and then injecting a Nth rubber selected from the rubbers used to form the product for mold forming, and then cooling to obtain the product completely.

Preferably, the rubbers include hard rubber and soft rubber.

Preferably, the preparation process of the hard rubber is that adding natural rubber and barium sulfate into an internal mixer, mixing for 20 to 40 min at temperature 120° C. to 140° C.; then adding high styrene, antioxidant SP, zinc oxide, stearic acid, polyethylene glycol and pigment powder B, continuously mixing for 8 to 12 min at 120° C. to 140° C. to obtain a rubber compound; cooling the rubber compound for 8 to 12 h after the rubber compound is extruded by an open mill; softening the cooled rubber compound by the open mill, and adding sulfur and accelerator after mill banding, performing mill run for 10 to 20 times and then extruding and cooling again, cutting the rubber after cooling for 3 to 5 h to obtain the hard rubber.

Preferably, the preparation process of the soft rubber is that adding natural rubber and nylon to an internal mixer, mixing for 20 to 40 min at a temperature of 120 to 140° C.; then adding high styrene, white carbon black, modified calcium carbonate, light calcium carbonate, antioxidant SP, zinc oxide, stearic acid, polyethylene glycol, silane coupling agent, plasticizer DOA and pigment powder A, continuously mixing for 8 to 12 min at 120 to 140° C. to obtain a rubber compound; cooling the rubber compound for 8 to 12 h after the rubber compound is extruded by an open mill; softening the cooled rubber compound by the open mill, and adding sulfur and accelerator after mill banding, performing mill run for 10 to 20 times and then extruding and cooling again, cutting the rubber after cooling for 3 to 5 h to obtain the soft rubber.

In view of the deficiencies of the prior art, the second objective of the present disclosure is to provide an integrated multi-color animal chew toy, which has the advantages of forming rubber of different colors in one body, so that the structural strength of the product is higher.

The second objective of the present disclosure is realized through the following technical solution: an integrated multi-color animal chew toy, a toy body processed by the above process, and the toy body is provided with an opening for holding food.

Preferably, the toy body is in a shape of a grenade.

Preferably, the opening includes a strip-like holding groove provided on a side of the toy body.

Preferably, the toy body is provided with a cavity inside, and the cavity is provided with a through hole communicating with outside.

As above, the disclosure has the advantageous effect that the preparation process uses two or more rubbers with different hardness and different colors to directly fuse together to form rubber of different colors in one body, so that the product structure strength is higher, the tear resistance is high, and there is no need to connect with buckles or glue, which can solve the problem of firmness, and enrich the visual and sensory requirements of the product.

### BRIEF DESCRIPTION OF THE DRAWINGS

FIG. 1 is a view showing of the structure of the disclosure in embodiment 2;

FIG. 2 is another view showing of the disclosure in embodiment 2 from another perspective.

The numbers in the figures: 1—Toy body; 11—Holding groove; 12—Cavity.

### DETAILED DESCRIPTION OF THE EMBODIMENTS

In order to further illustrate the technical problem, the technical solution and the technical effect of the disclosure more apparently, it is necessary to further explain the disclosure with the embodiments and the attached drawings. It should be understood that the specific embodiments described herein are only for the purpose of explaining the present disclosure and are not intended to limit the present disclosure.

It should be noted that when a component is referred to as “fixed to” or “set to” another component, it can be directly or indirectly on the other component. When a component is said to be “connected” to another component, it can be directly or indirectly connected to that other component.

It should be understood that the terms “length”, “width”, “upper”, “lower”, “front”, “back”, “left”, “right”, “vertical”, “horizontal”, “top”, “bottom”, “inside” and “outside” are based on the orientation or position relationship shown in the attached drawings and are only for the convenience of describing the disclosure and simplifying the description, which should not understood that the device or element indicted or implied must have a specific orientation or be constructed and operated in a specific orientation, and therefore cannot be understood as a limitation of the present disclosure.

In addition, the terms “first” and “second” are used only for the purpose of description and cannot be understood as indicating or implying relative importance or implicitly indicating the number of technical features indicated. Thus, the features defined as “first” and “second” may explicitly or implicitly include one or more of the features. In the description of this disclosure, “a plurality of” means two or more, unless otherwise specified.

Embodiment 1: The preparation process of an integrated multi-color animal chew toy, which includes the following steps:

Material selection: N types of rubbers used to form a product are selected, wherein the rubbers have different colors and different hardness;

The first time of processing: one type of rubber from the rubbers used to form the product is selected, the rubber selected is put into the first mold, and the mold forming is performed to form the first molded product;

The second time of processing: part of the first molded product is put into the second mold, the second mold is closed and then the second rubber selected from the rubbers used to form the product is injected for mold forming to form the second molded product;

N times of processing: part of the second molded product is put into the Nth mold, the Nth mold is closed and then the Nth rubber selected from the rubbers used to form the product is injected for mold forming, and then the complete product is obtained after cooling.

Preferably, the rubbers include hard rubber and soft rubber.

Preferably, the preparation process of the hard rubber is that natural rubber and barium sulfate are added into an internal mixer to mix for 20 to 40 min at temperature 120° C. to 140° C.; then high styrene, antioxidant SP, zinc oxide, stearic acid, polyethylene glycol and pigment powder B are added and continuously mixed for 8 to 12 min at 120° C. to 140° C. to obtain a rubber compound. The rubber compound is cooled for 8 to 12 h after the rubber compound is extruded by an open mill. The cooled rubber compound is softened by the open mill, and then sulfur and accelerator are added after mill banding. Mill run is performed for 10 to 20 times, and then extrusion and cooling are performed again, the rubber is cut after cooling for 3 to 5 h to obtain the hard rubber.

Preferably, the preparation process of the soft rubber is that natural rubber and nylon are added to an internal mixer to mix for 20 to 40 min at a temperature of 120 to 140° C. Then, high styrene, white carbon black, modified calcium carbonate, light calcium carbonate, antioxidant SP, zinc oxide, stearic acid, polyethylene glycol, silane coupling agent, plasticizer DOA and pigment powder A are added and continuously mixed for 8 to 12 min at 120 to 140° C. to obtain a rubber compound. The rubber compound is cooled for 8 to 12 h after the rubber compound is extruded by an open mill. The cooled rubber compound is softened by the open mill, and sulfur and accelerator are added after mill banding. Mill run is performed for 10 to 20 times, and then extrusion and cooling are performed again, the rubber is cut after cooling for 3 to 5 h to obtain the soft rubber.

The preparation process uses two or more rubbers with different hardness and different colors to directly fuse together to form rubber of different colors in one body, so that the product structure strength is higher, the tear resistance is high, and there is no need to connect with buckles or glue, which can solve the problem of firmness, and enrich the visual and sensory requirements of the product.

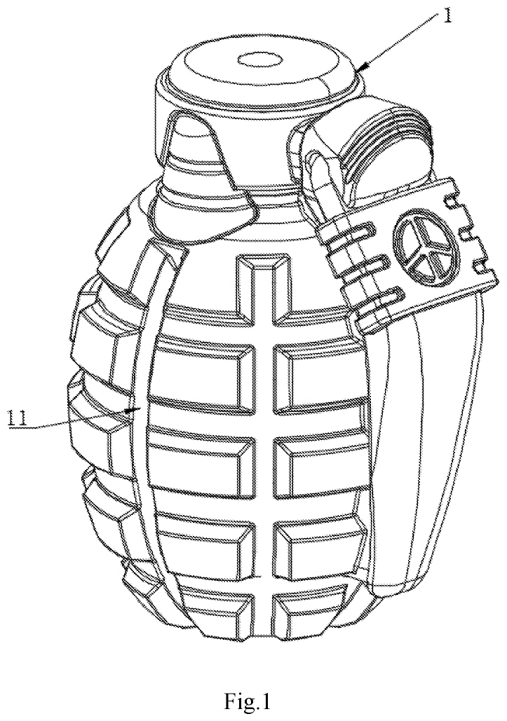

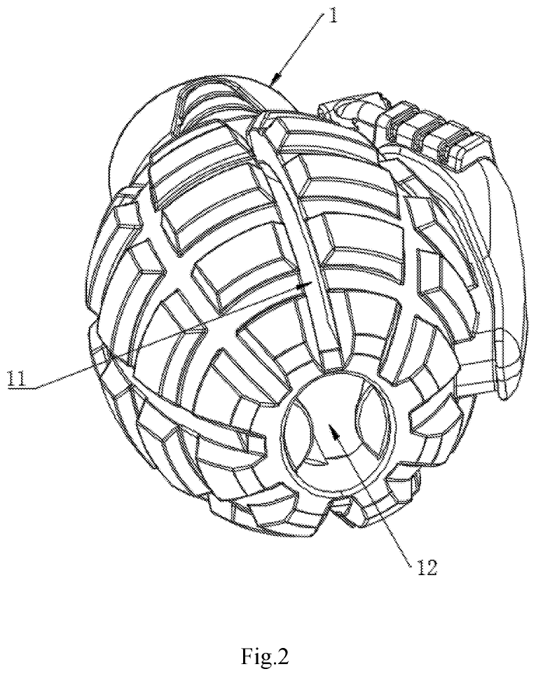

Embodiment 2: An integrated multi-color animal chew toy, as shown in FIG. 1 and FIG. 2, the toy body 1 is processed by the process described in embodiment 1, and the toy body 1 is provided with an opening for holding food. The opening is provided to facilitate the owner to put food into the opening, so that the pet can eat the food when biting the toy.

Preferably, the toy body 1 is in the shape of grenade. Of course, according to the actual situation, the toy body can also be in the shape of other fruits.

Preferably, the opening includes a strip-like holding groove 11 provided on the side of the toy body 1.

Preferably, the toy body 1 is provided with a cavity 12 inside, and the cavity 12 is provided with a through hole communicating with the outside.

The above mentioned embodiments are only interpretations of the disclosure, and those are not limitations to the disclosure. After reading the description, one person skilled in the art maybe modify the embodiment without creative contribution according to the actual requirement, but it is still protected by the patent law as long as within the scope of the claims of the disclosure.

What is claimed is:

1. A preparation process of an integrated multi-color animal chew toy, comprising
material selection: selecting N types of rubbers used to form a product, wherein the rubbers have different colors and different hardness;
a first time of processing: selecting one type of rubber from the rubbers used to form the product, putting the rubber selected into a first mold, and performing mold forming to form a first molded product;
a second time of processing: putting part of the first molded product into a second mold, closing the second mold, and then injecting a second rubber selected from the rubbers used to form the product for mold forming to form a second molded product;
N times of processing: putting part of the second molded product into a Nth mold, closing the Nth mold, and then injecting a Nth rubber selected from the rubbers used to form the product for mold forming, and then cooling to obtain the product completely.

2. The preparation process of the integrated multi-color animal chew toy according to claim 1, wherein the rubbers comprise hard rubber and soft rubber.

3. The preparation process of the integrated multi-color animal chew toy according to claim 2, wherein a preparation process of the hard rubber is that adding natural rubber and barium sulfate into an internal mixer, mixing for 20 to 40 min at temperature 120° C. to 140° C.; then adding high styrene, antioxidant SP, zinc oxide, stearic acid, polyethylene glycol and pigment powder B, continuously mixing for 8 to 12 min at 120° C. to 140° C. to obtain a rubber compound; cooling the rubber compound for 8 to 12 h after the rubber compound is extruded by an open mill; softening the cooled rubber compound by the open mill, and adding sulfur and accelerator after mill banding, performing mill run for 10 to 20 times and then extruding and cooling again, cutting the rubber after cooling for 3 to 5 h to obtain the hard rubber.

4. The preparation process of the integrated multi-color animal chew toy according to claim 2, wherein a preparation process of the soft rubber is that adding natural rubber and nylon to an internal mixer, mixing for 20 to 40 min at a temperature of 120 to 140° C.; then adding high styrene, white carbon black, modified calcium carbonate, light calcium carbonate, antioxidant SP, zinc oxide, stearic acid, polyethylene glycol, silane coupling agent, plasticizer DOA and pigment powder A, continuously mixing for 8 to 12 min at 120 to 140° C. to obtain a rubber compound; cooling the rubber compound for 8 to 12 h after the rubber compound is extruded by an open mill; softening the cooled rubber compound by the open mill, and adding sulfur and accelerator after mill banding, performing mill run for 10 to 20 times and then extruding and cooling again, cutting the rubber after cooling for 3 to 5 h to obtain the soft rubber.

5. An integrated multi-color animal chew toy, comprising a toy body processed by a preparation process of the integrated multi-color animal chew toy, and the toy body is provided with an opening for holding food;
wherein the preparation process of the integrated multi-color animal chew toy, comprising
selecting N types of rubbers used to form a product, wherein the rubbers have different colors and different hardness;
selecting one type of rubber from the rubbers used to form the product, putting the rubber selected into a first mold, and performing mold forming to form a first molded product;
putting part of the first molded product into a second mold, closing the second mold, and then injecting a second rubber selected from the rubbers used to form the product for mold forming to form a second molded product;
putting part of the second molded product into a Nth mold, closing the Nth mold, and then injecting a Nth rubber selected from the rubbers used to form the product for mold forming, and then cooling to obtain the product completely.

6. The integrated multi-color animal chew toy according to claim 5, wherein the toy body is in a shape of a grenade.

7. The integrated multi-color animal chew toy according to claim 6, wherein the opening comprises a strip-like holding groove provided on a side of the toy body.

8. The integrated multi-color animal chew toy according to claim 6, wherein the toy body is provided with a cavity inside, and the cavity is provided with a through hole communicating with outside.
